(19) United States
(12) Patent Application Publication
(10) Pub. No.: US 2011/0307569 A1
(43) Pub. Date: Dec. 15, 2011

(54) SYSTEM AND METHOD FOR COLLABORATIVE SHORT MESSAGING AND DISCUSSION

(75) Inventors: David O. SACKS, Beverly Hills, CA (US); Adam Marc Pisoni, Santa Monica, CA (US); Alan Michael Braverman, Los Angeles, CA (US); Amos Eagle Elliston, Los Angeles, CA (US); Elliot Pak-chun Loh, West Hollywood, CA (US)

(73) Assignee: Yammer, Inc., San Francisco, CA (US)

(21) Appl. No.: 13/217,213

(22) Filed: Aug. 24, 2011

Related U.S. Application Data
(62) Division of application No. 12/555,800, filed on Sep. 8, 2009.
(60) Provisional application No. 61/094,818, filed on Sep. 5, 2008.

(51) Int. Cl. G06F 15/16

(52) U.S. Cl. 709/206

(57) ABSTRACT

A system and method for collaborative short messaging and discussion are described. According to one embodiment, a computer-implemented method for collaborative short messaging and discussion, comprises grouping users into client networks based on existing shared attributes. System resources are partitioned for messaging across client networks. Users in a client network are allowed to view or respond only to messages within the client network.

The present application is a divisional of U.S. patent application Ser. No. 12/555,800, filed Sep. 8, 2009 which claims the benefit of and priority to U.S. Provisional Patent Application No. 61/094,818 entitled “System and Method for Collaborative Short Messaging and Discussion” and filed on Sep. 5, 2008.

### FIELD

The present invention relates to electronic messaging over the Internet, and more particularly to a system and method for collaborative short messaging and discussion.

### BACKGROUND

Online and mobile social networking applications allow users to create an account online and to send and receive messages to and from other users, and view messages posted by other users. Typically users create a profile and define their network of associated users by inviting other users to join their network or by using software to find existing relationships recorded on computer (e.g. Facebook, Myspace, and LinkedIn).

More recently, miqo-blogging has become an effective means of collaborative discussion, allowing participants to share information at any given moment on a particular topic. In micro-blogging social networks (e.g. Twitter), users can send and receive messages through a website, Short Message Service (SMS), or dedicated application software. But like typical social networking applications, micro-blogging social networks have minimal message threading capabilities. A user searching for the most recent information on a particular topic is likely to be presented with many messages that are irrelevant because the core of the message is not necessarily directed to the topic searched.

### SUMMARY

A system and method for collaborative short messaging and discussion are described. According to one embodiment, a computer-implemented method for collaborative short messaging and discussion, comprises grouping users into client networks based on existing shared attributes. System resources are partitioned for messaging across client networks. Users in a client network are allowed to view or respond only to messages within the client network.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates an exemplary system for collaborative short messaging and discussion, according to one embodiment;

FIG. 2 illustrates exemplary embodiments of the web client interface for use with the present system, according to one embodiment;

FIG. 3 illustrates a block diagram of an exemplary process for message distribution, according to one embodiment;

FIG. 4 illustrates a flow chart of an exemplary process for message processing, according to one embodiment;

FIG. 5 illustrates an exemplary data structure for storing and associating messages, according to one embodiment;

FIG. 6 illustrates a flow chart of an exemplary process for message broadcasting, according to one embodiment;

FIG. 7 illustrates a flow chart of an exemplary process for caching message feeds, according to one embodiment; and

FIG. 8 illustrates a flow chart of an exemplary process for a web message request; according to one embodiment.

It should be noted that the figures are not necessarily drawn to scale and that elements of similar structures or functions are generally represented by like reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A system and method for collaborative short messaging and discussion are disclosed. According to one embodiment, a computer network short messaging and discussion system designed for collaboration within an existing group. Features include message threading and tagging with keywords, and private messages and groups.

In one embodiment the present system is network partitioned: Users are grouped into a client network based on the domain portion of their email addresses. For example, joe@foo.com and bob@foo.com will both be members of the foo.com client network, and only have access to its contents. Because there is no overlap of data between client networks, databases and other resources can be partitioned into groups of networks.

In the following description, for purposes of explanation, specific nomenclature is set forth to provide a thorough understanding of the various inventive concepts disclosed herein. However, it will be apparent to one skilled in the art that these specific details are not required in order to practice the various inventive concepts disclosed herein.

System Architecture

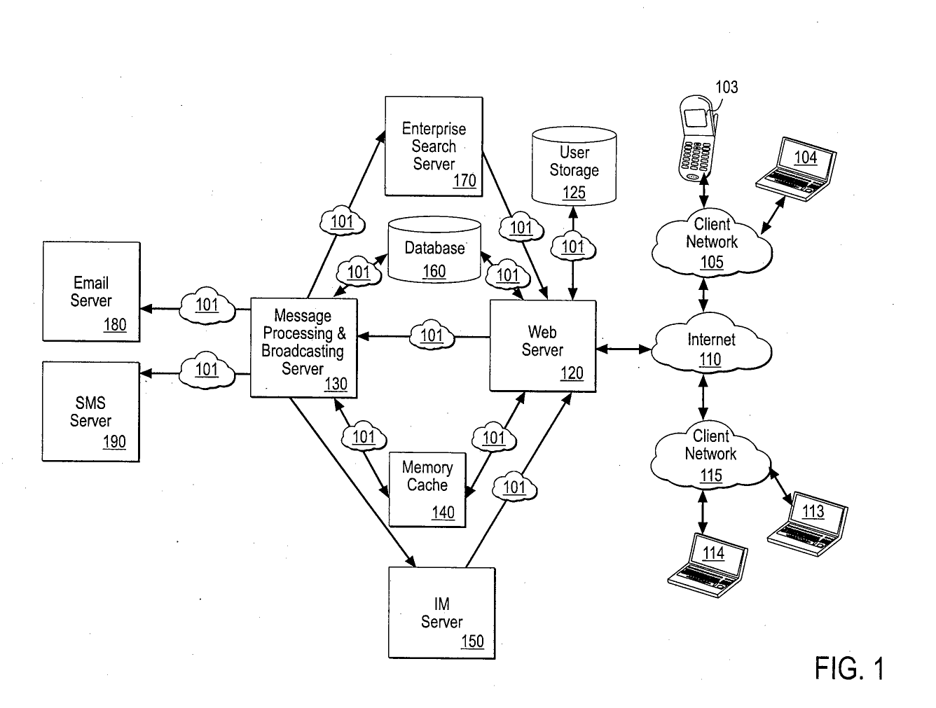

FIG. 1 illustrates an exemplary system for collaborative short messaging and discussion, according to one embodiment. System 100 includes client devices 103, 104, 113, and 114, client networks 105, and 115 with which client devices are associated, internet 110, network(s) 101, web server 120, user storage 125, message processing and broadcasting server 130, memory cache 140, instant message (IM) server 150, database 160, enterprise search server 170, email server 180 and SMS server 190.

System 100 is interconnected by the internet 110 and network(s) 101. According to one embodiment, network(s) 101 is described as being the internet; alternatively, network(s) 101 may be Wide Area Networks (WAN), a Local Area Networks (LAN), or any other system of interconnection enabling two or more devices to exchange information.

One or more client devices 103, 104, 113, and 114 allow web access via browsers such as Microsoft Internet explorer, Apple Safari, Mozilla, Firefox or any other browser that supports HTML and JavaScript that may allow network access via the web. Client devices 104, 113, and 114 may personal computers. Client device 103 is a web enabled phone or other web enabled mobile device. Alternatively client device 103 is a non-web-enabled mobile phone capable of SMS.

Users of client devices 103, 104, 113, and 114, are grouped into client networks. A user in system 100 is a specific person's account associated with a single client network. A client network is a collection of users, messages, and keyword tags. In a client network a user only has the ability to see public information of other users in that client network; users outside the client network cannot see any information in a client network unless they are specifically granted access to such a client network. In the preferred embodiment, users are grouped into client networks based on the domain portion of the users' email address. For example, in FIG. 1, users of client devices 103 and 104 are grouped in client network 105 because they share the same email domain (e.g. joe@foo.com and bob@foo.com). Likewise, users of client devices 113, and 114 are grouped in client network 115 because they share the same email domain.

Web server 120 is a web server that uses any of protocols and/or applications including Hypertext transfer Protocol (HTTP), File Transfer Protocol (FTP), Extensible Messaging and Presence Protocol (XMPP), or other similar connection protocols. The operating system may be Windows, LINUX, SUN Solaris, Mac OS, or other similar operating system. Users create an account on web server 120 and are grouped into client networks. Messages are sent from client devices 103, 104, 113 or 114 to web server 120 through internet 110. Messages are received via web server 120, email server 180, and/or SMS server 190.

Message processing and broadcasting server 130 is a server capable of processing the content of messages, operating a message queue, and directing messages to the appropriate resource in system 100. The operating system may be Windows, LINUX, SUN Solaris, Mac OS, or other similar operating system. Message processing and broadcasting server 130 may distribute messages to email server 180, SMS server 190, IM server 150, memory cache 140, database 160, and enterprise search server 170.

Instant message server 150 is a server using any protocols and/or applications for sending instant messages including Extensible Messaging and Presence Protocol (XMPP), ejabberd, and Bi-Directional-Streams Over HTTP (BOSH). Enterprise search server 170 is a server using any protocol and/or application for enterprise searches such as Apche's Solr.

User Storage 125 is a storage drive or other device capable of file storage. Preferably user photos are stored in user storage 125.

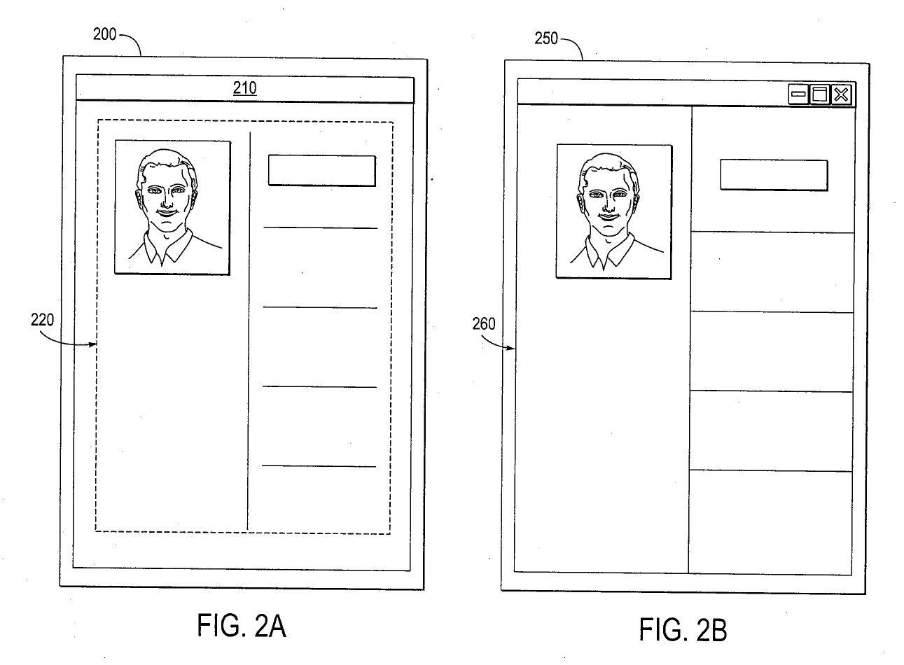

FIG. 2 illustrates exemplary embodiments of the web client interface for use with the present system, according to one embodiment. In one embodiment, web client interface 220 operates through a web browser 210 on client device 200. In another embodiment, web client interface 260 is designated application software for a personal computer operating Microsoft Windows, or Mac OS, or application software for a mobile device such as Apple's iPhone, RIM's Blackberry, or Google's Android for example.

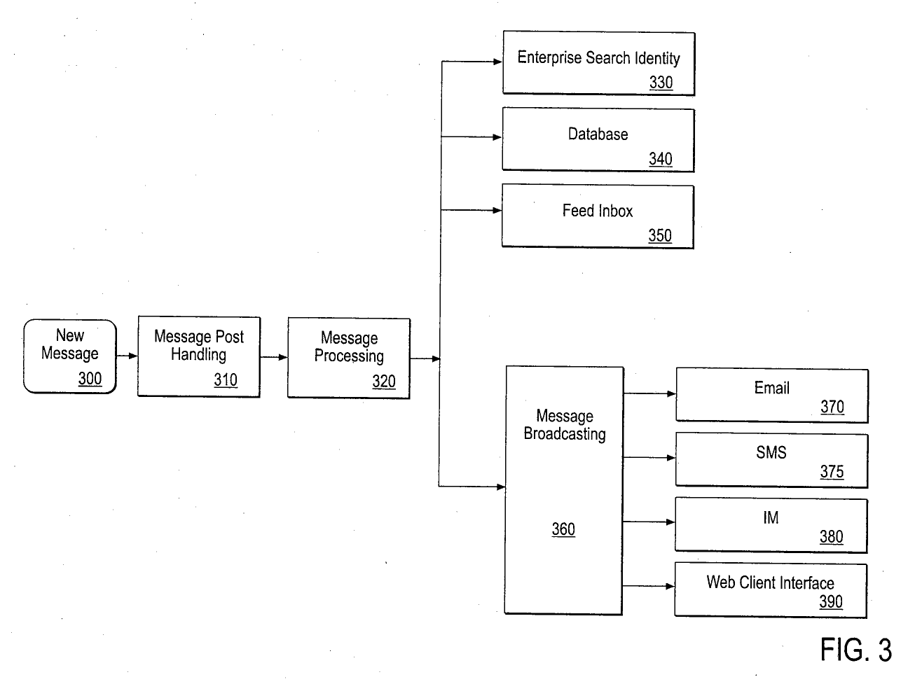

FIG. 3 illustrates a block diagram of a process for message distribution, according to one embodiment. Messages need to be delivered to all connected clients. This includes clients connected via the web client interface 390, SMS 375, email 370, Instant Message 380, or other communication schemes. According to one embodiment, system 100 delivers the “all” feed to users who request it. Additional embodiments include rate-limiting this feed (and dropping messages when the messaging rate is too high), or simply removing it as an option for some or all clients.

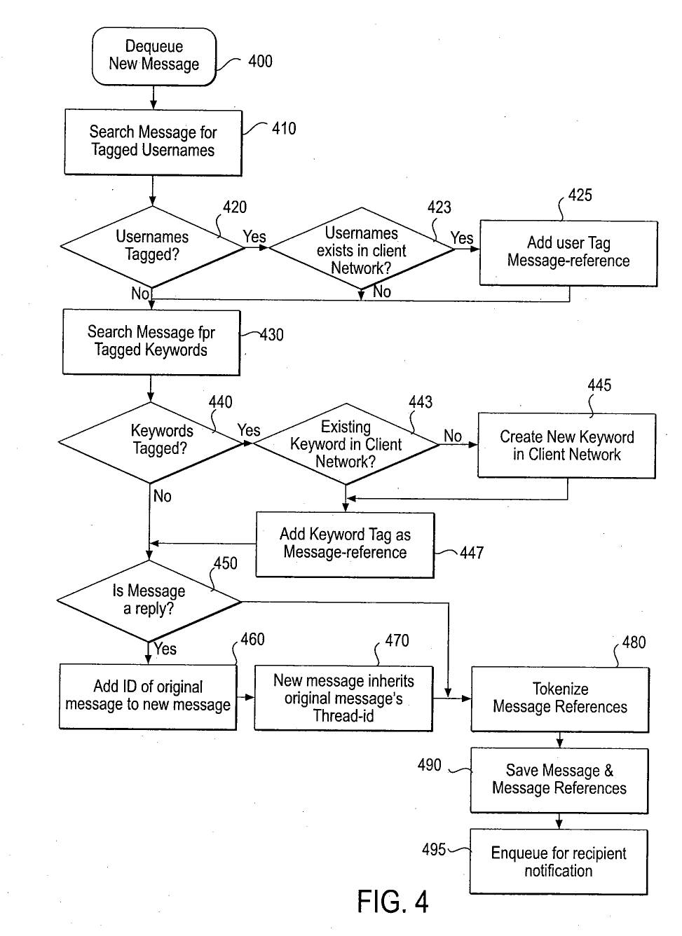

Before a new message 300 is sent out, it is subjected to message post handling 310 on the client device. For example, during message post handling, the user is able to view the message before it is transmitted. Once the message is sent from the client device and received by the system, the message is subject to message processing 320 which is discussed in detail in FIG. 4. After message processing 320, the new message is dispersed across system resources. These include enterprise search 330, database 340, message feeds 350 and message broadcasting 360. Enterprise search 330 allows for word searches within message. Feed Inbox 350 associates the new message with all message feeds that the message is relevant to, and database 360 archives the message.

For push delivery, a notification table describing which message feeds users want and by which delivery method (e.g. IM, SMS, email) is consulted. During message broadcasting 360, messages are then handed off to the appropriate delivery system depending on which method (e.g. IM, SMS, email) user has enabled for delivery. Some delivery systems may have further configuration parameters (windows of delivery time, for example, or a global on/off toggle), and this configuration parameter is consulted before delivering a message.

Tagging Messages

In the present system for collaborative short messaging and discussion users have the option of tagging messages for users and/or keywords. This tagging feature allows users to seamlessly direct messages to relevant message feeds during composition of the message. It also allows users within the client network to search the client network for messages tagged with a particular user, or messages tagged with a particular keyword. Further, it allows users to subscribe to message feeds containing user specified tags. In one embodiment, users can tag other users in the body of a message by prefixing a username with “@”. Likewise, users can tag keywords by prefixing a keyword with a pound “#” sign. For example:

Zack Parker: Hey @kgale, check with @apisoni to see if he's done with the #im gateway for #workfeed.

This message from user Zack Parker is tagged with “im” and “workfeed” , along with users kgale and apisoni. Replies to this message will inherit all of these tags (both keyword and user), so a user following the tags will see relevant replies without people having to remember to keep tagging all messages in the thread. For Example, David Sacks in reply to Zack Parker:

David Sacks: I just talked to Adam. He said he was done and moving on to his #skynet presentation.

This reply from user David Sacks to the original message from user Zack Parker is tagged with users kgale and apisoni, keywords “im”, “workfeed”, and now keyword “skynet”. Note that the “skynet” tag does not apply to the original, but it will apply to any responses to this message.

Message Processing

FIG. 4 illustrates a flow chart of an exemplary process for message processing, according to one embodiment.

First, a new message is dequeued (400) from the message queue and the body of the message is searched for tagged usernames (410). If username tags are found (420) then the sender's client network is searched to determine whether the tagged username(s) exist in the client network (423). If a tagged username exists within the client network, a username tag is added to the message as a reference (425) and the process proceeds. If no username tags are found (420), or the username does not exist in the sender's client network, then the process proceeds.

The body of the message is searched for tagged keywords (430). If a keyword tag is found (440), the system checks whether the keyword already exists in the sender's client network as a keyword (443). If the tagged keyword does not presently exist in the client network as a keyword, a keyword tag is created in the client network (445) and a keyword tag is added to the message as a reference (447). And if the tagged keyword already exists in the sender's client network as a keyword it is added to the message as a reference (447).

Once the message is screened for tags, it is determined whether the message is a reply to another message (450). As a result of the determination (450), if the message is a reply, the message receives the message ID of the original message (460) and inherits the original message's thread ID (470), this allows for message threading. Messages which are not replies are given a new thread ID matching its new message ID; when a message's ID matches its thread ID, it is a “thread starter”. Thus, while threads are only 1 level deep, replies maintain the knowledge of the message they were in reply to.

Tags in the body of the message are stored as special tokens (480) that are later replaced with links, or similar mechanisms, when the message is displayed on the web client interface. After all tags in the body of the message are tokenized (480), the message is saved (490) and enqueued for recipient notification (495).

Structure of a Message

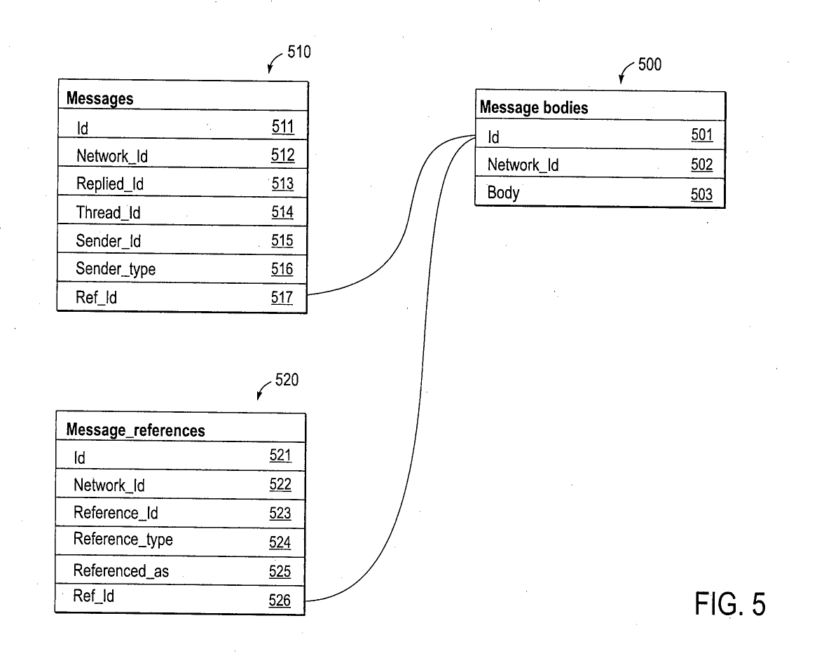

In the present system for collaborative short massaging and discussion, although messages are relatively small, many updates are posted through SMS and IM. And given that the web client interface encourages small messages, in the preferred embodiment, most messages will tend to be under 200 characters, but no character limit is imposed. FIG. 5 illustrates an exemplary data structure for storing messages, according to one embodiment.

New messages are stored starting with the body, then the references, and finally the row with the meta-data in the messages table. This ensures new messages showing up in the sequence of message IDs are immediately ready for delivery.

The structure of a message consists of table 500 and associated tables 510 and 520. Table 500 contains the message Id 501, the network the message is associated with—Network_id 502—and the massage body or pointer to the message body, Body 503, according to one embodiment. Associated table 510 contains information for message transmittal and threading. These include Id 511, Network_id 512, Replied_id 513, Thread_id 514, Sender_id 515, Sender_type 516, and Ref_id 517. Associated table 520 includes information for a message reference, such as tagged keyword. These include Id 521, Network_id 522, Reference_id 523, Reference_type 524, Reference_as 525, and Ref_id 526.

The row called Referenced_as allows for association of different types of references with individual messages. The possible values of Referenced_as are “re”, “to”, “tagged” or “in_thread”. The type “re” is used when the referenced_type is a user, and that user was the sender of the message that this message is in reply to. For example, if Zack sends a message that David replies to, David's message will have a message_references record where referenced_id/referenced_type map to his user object, and referenced_as is set to “re”. The type “to” allows directed messages. “Tagged” is used for those things explicitly tagged in the body of a message using @ or #, or similar tagging identifier. “In_thread” is used when references are inherited from previous messages in the thread.

The present system for collaborative short massaging and discussion uses this list as a hierarchy to determine whether the value in referenced_as is “tagged” or better, meaning “re”, “to”, or “tagged” but not just “in_thread”. This hierarchy is also used to prevent saving the same reference twice. If user David replies to user apisoni and also puts “@apisoni” in the body, only one reference will be stored, using “re” instead of “tagged”.

From the example reply above, the four inherited references (#im, #workfeed, @apisoni, @kgale) would be stored with referenced_as=in_thread, and the new reference (#skynet) would be stored with referenced_as=tagged. Another “re” reference will have to be added for the user representing Zack Parker.

The distinction between “tagged” and “in_thread” is best illustrated by comparing the list of messages seen on a tag's page (in_thread or better) to those seen on a user's “received” tab (tagged or better.) This makes the received tab clearer, as all messages shown there explicitly reference the user in the body of the message.

Threading is accomplished by giving users a reply feature which tags the new message with the ID of the original, as well as inheriting the original message's thread ID. Messages which are not replies are given a new thread ID matching its message ID; when a message's ID matches its thread ID, it is a “thread starter”.

Message Broadcasting

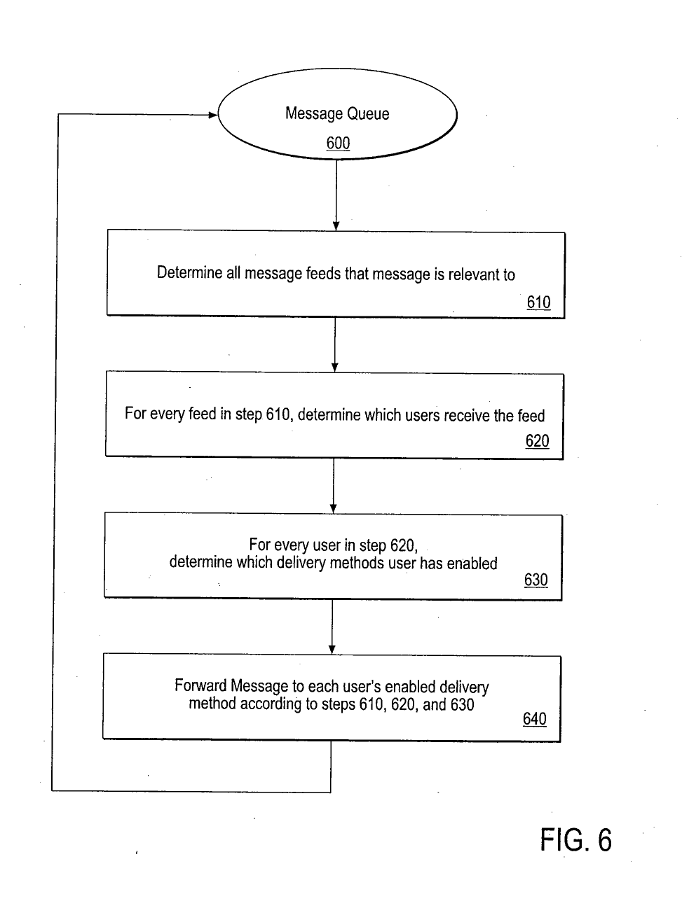

FIG. 6 illustrates a flow chart of an exemplary process for message broadcasting, according to one embodiment. The process begins by pulling a message from the message queue (600). The process determined all the message feeds that the message is relevant to (610). For every message feed that the message is relevant to (610), the process determines which users receive those feeds (620). For every user which receives the feed(s), the process determines which delivery methods the user has enabled (e.g. email, SMS, IM) (630). The message is then forwarded to each users' enabled delivery method according to steps 610, 620, and 630 and the process is repeated as long as there are messages in the message queue (600).

Message Feeds and Subscriptions

To enable the system to scale to handle very large numbers of users and messages, the system organizes messages at the time of creation into feeds. The present system for collaborative short massaging and discussion identifies collections of messages, or feeds, which are related in some way.

A user wishing to view messages selects the appropriate feed and has immediate access to messages within that feed without having to do expensive (e.g. time consuming and resource intensive) queries against a relational database. The system handles several orders of magnitude—more reads than writes—so the system allows the difficult work of figuring out if a message should be visible in a given context to be handled once during message creation, rather than hundreds or thousands of times during a message's visible lifetime.

Message delivery writes ahead directly into the feed cache, which is used during message polling. This allows the system to handle the vast majority of feeds from in-memory cache without using a relational database or fetching messages from hard drives.

Examples of message feeds include: all public messages in a particular client network, all messages in a particular client network not in a specific group, messages from a specific user, messages sent by a specific user, messages in a specific group, messages in a specific group by a specific user, messages in a specific group also tagged with a specific keyword, private messages to a specific user, messages tagged with a specific keyword, messages from all bots “followed” by a specific user (see subscriptions below), messages from a specific bot, messages referencing or in reply to a specific user, messages representing a chain of replies, messages “followed” by a specific user (see subscriptions below), messages within a specific conversation which is an ad-hoc collection of messages not organized by reply chain, and messages marked by a specific user as favorites.

Subscriptions come in two verities, according to one embodiment. The first verity of subscription occurs when a user subscribes to another user's message feed or to a feed for a tagged keyword. The second verity of subscription occurs when a user selects a particular delivery method (e.g. email, SMS, IM) for a feed.

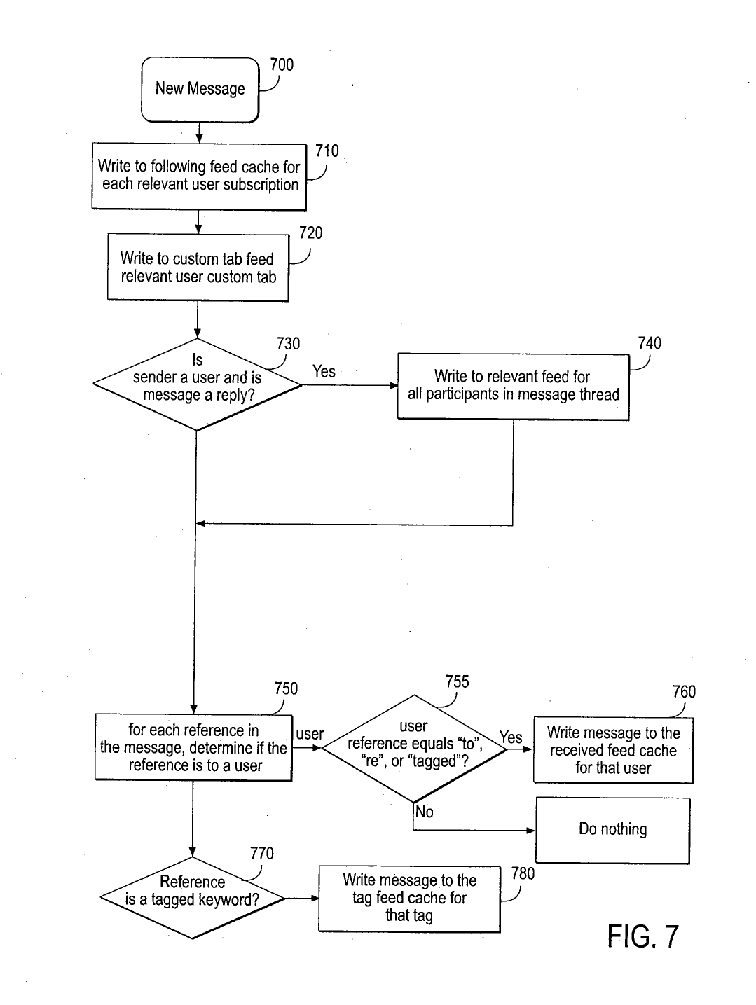

FIG. 7 illustrates a block diagram of a process for caching message feeds, according to one embodiment. New messages (700) are written to the following feed cache for each relevant user subscription (710). Messages are then written to the custom tab feed cache for each relevant user custom tab (720). It is then determined whether a user is the sender of the message and if the message is a reply (730). If a user is the sender of the message and the message is a reply (730) then messages are written to the relevant feed caches for all participants in the message thread (740).

For each reference in a message, it is determined whether the reference is to the user (750). Messages with references “to” the user, in reply “re” to the user, or where the user is tagged in the message (755), are written to the received feed cache for that user (760). Messages that contain tags of keywords (770), are written to the tag feed cache (780).

Web Message Requests

Users connected to the system for collaborative short messaging and discussion through the web client interface can view a number of pages with message feeds including messages with a particular tag, a user's “updates” (their non-replies), a user's “replies” (their replies to others), a user's own “following” tab or any of their custom following tabs, a user sent tab, a user's received tab (all messages that mention or are in reply to that user), or all messages in the client network, according to one embodiment. Any of these pages can be viewed in threaded mode.

Each user has a unique Jabber ID (“JID”). When a user views a page on the web client interface, a unique resource is generated and assigned to that user's JID for that page/request. For example, if user David requests all messages with the keyword “workfeed”, a resource is generated as the identifier for that request and assigned to David's JID. This JID/resource combination is subscribed to the feed the user is looking at so that new messages to that feed will be delivered to that user. The JID/resource is unsubscribed from the feed when it sends an offline presence. Database 160 and memory cache 140 store the record of which JIDs are presently subscribed to which feeds.

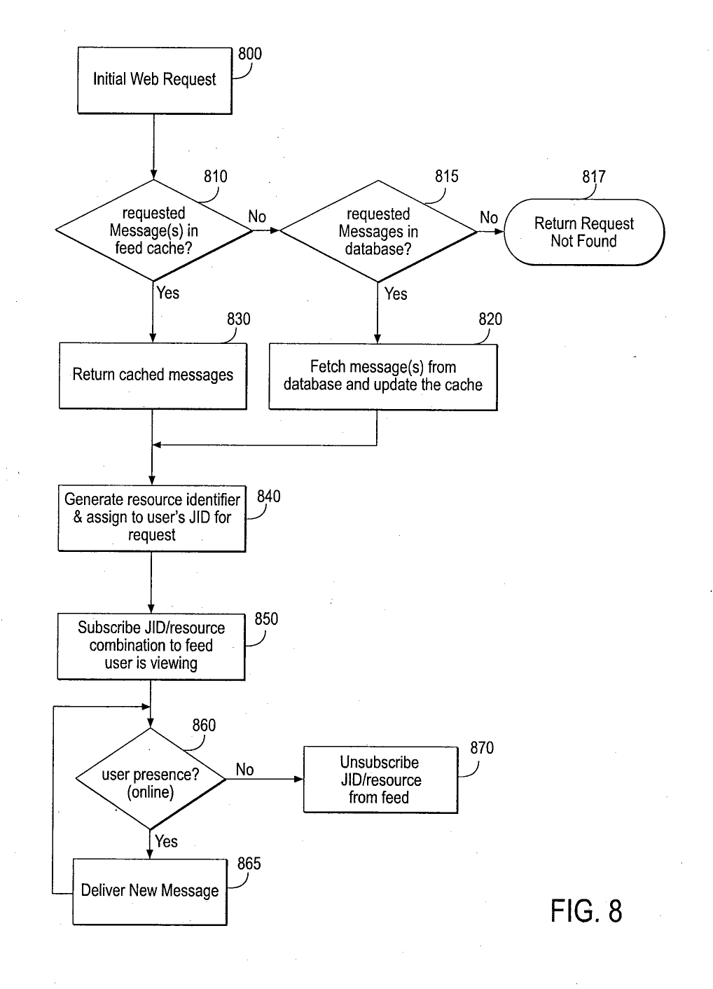

FIG. 8 illustrates a flow chart of an exemplary process for a web message request, according to one embodiment. When an initial request is made for a page with a particular message feed (800), the message feed cache is searched for messages relevant to the request (810) and returns all relevant cached messages (820). If no relevant messages are found (810), then the database is searched for relevant messages (815). If relevant messages are found in the database (815), the database returns the relevant messages and the cache is updated (820), otherwise no relevant messages exist and the system returns an error (817).

When the relevant messages are returned a unique resource is generated and assigned to that user's JID for that page/request (840). That JID/resource combination is subscribed to the feed the user is viewing (850). If the user remains online, then new messages to the feed are delivered to the user (865). If the user is no longer present online the user's JID/resource is unsubscribed from the feed.

We claim:

1. A computer-implemented method for managing collaborative short messaging and discussion within client social networks including a first client social network and a second client social network, comprising:
receiving a message from a user of the first client social network, the message including a tagged string;
determining one or more feeds that are associated with at least one of the user and the tagged string, wherein the one or more feeds are accessible by users of the first client social network but not by users of the second client social network;
adding the message to the one or more feeds that are determined to be associated with at least one of the user and the tagged string; and
delivering the message to users of the first client social network who are subscribed to the one or more feeds and are viewing any of the one or more feeds.

2. The method of claim 1, further comprising the step of:
prior to the step of delivering, replacing the tagged string in the message with a link.

3. The method of claim 1, wherein the tagged string comprises a keyword.

4. The method of claim 1, further comprising the step of:
in response to determining that the tagged string is not associated with a feed, creating a new feed that is associated with the tagged string and accessible by users of the first client social network but not by users of the second client social network.

5. The method of claim 2, wherein the tagged string comprises a username.

6. The method of claim 5, further comprising the step of:
determining that the username is not registered within the first client social network; and
removing the link.

7. The method of claim 1, wherein the tagged string is identified via a predetermined symbol that is prefixed to the tagged string.
